(19) United States
(12) Patent Application Publication
(10) Pub. No.: US 2013/0119884 A1
(43) Pub. Date: May 16, 2013

(54) LIGHT SOURCE MODULE

(71) Applicants: TA-SHENG HUNG, Taichung City (TW); Lien-Ta Chien, New Taipei City (TW)

(72) Inventors: TA-SHENG HUNG, Taichung City (TW); Lien-Ta Chien, New Taipei City (TW)

(73) Assignee: HEP TECH CO., LTD., Taichung City (TW)

(21) Appl. No.: 13/340,196

(22) Filed: Dec. 29, 2011

(30) Foreign Application Priority Data
Nov. 15, 2011 (TW) 100141563

(51) Int. Cl. H05B 37/02

(52) U.S. Cl. 315/219

(57) ABSTRACT

The present invention provides a light source module, including at least a LED and a switching power supply. The switching power supply has an input port, an output port, a transforming unit, and a switching unit. An external power source is connected to the input port, the LED is electrically connected to the output port, and the transforming unit is between the input port and the output port to receive power of the external power source through the input port, transform the power, and send the power to the light emitting diode through the output port. The switching unit includes a ringing choke converter electrically connected to the transforming unit to make the transforming unit provide a constant current to the LED by turning on and turning off the power outputting from the transforming unit.

### BACKGROUND OF THE INVENTION

1. Field of the Invention

The present invention relates generally to an optical device, and more particularly to a light source module.

2. Description of the Related Art

With advancement in technology, light-emitting diode (LED) is more and more popular in the modern market. LED has many advantages, including small size, short response time, long life, low decrement, strong surface, anti-vibration, emitting full-color light (including invisible light), low power loss, low radiant heat, and easy to manufacture. Therefore, more and more light sources use LED to replace conventional light bubble or tube.

The difference between the LED and other electronic devices is that LED is activated by current, not by voltage. Consequently, a LED light source module usually is provided with a constant current switching power supply for supplying LEDs stable and constant current.

In the present market, the switching power supply usually is provided with IC chip to supply constant current. However, IC chip is expensive, and needs extra power to drive it, and that will need more power for the light source module and slow down the reaction. While the light source module is provided with a dimmer to adjust the LEDs, there will be hunting phenomenon between the dimmer and the switching power supply to cause LEDs flashing. Consequently, the conventional light source module still has some parts that need to improve.

### SUMMARY OF THE INVENTION

The primary objective of the present invention is to provide a light source module, which has low cost and fast reaction.

According to the objective of the present invention, the present invention provides a light source module, including at least a light emitting diode and a switching power supply. The switching power supply has an input port, an output port, a transforming unit, and a switching unit. An external power source is connected to the input port, the light emitting diode is electrically connected to the output port, and the transforming unit is between the input port and the output port to receive power of the external power source through the input port, transform the power, and send the power to the light emitting diode through the output port. The switching unit includes a ringing choke converter electrically connected to the transforming unit to make the transforming unit provide a constant current to the light emitting diode by turning on and turning off the power outputting from the transforming unit.

In an embodiment, the present invention further provides a voltage compensation unit electrically connected to the switching unit. The voltage compensation unit controls the switching unit to make the transforming unit provide a constant current to the light emitting diode when voltage of the external power source changes.

In an embodiment, the present invention further provides a temperature compensation unit electrically connected to the switching unit. The temperature compensation unit controls the switching unit to make the transforming unit provide a constant current to the light emitting diode when temperature of the switching unit changes.

In an embodiment, the voltage compensation unit includes a diode, a capacity, and parallel resistors in series.

In an embodiment, the temperature compensation unit includes a thermistor.

In an embodiment, the transforming unit further includes a DC/DC inverter to transform the power form the external power source, and send the power to the light emitting diode.

In an embodiment, the transforming unit further includes a rectifier electrically connected to the input port to transform the power from the external power source into DC current, and send the DC current to the DC/DC converter.

Therefore, the present invention may provide a constant current without IC chip to reduce the cost of the light source module and increase the speed of reaction.

### BRIEF DESCRIPTION OF THE DRAWINGS

FIG. 1 is a block diagram of a first preferred embodiment of the present invention;

FIG. 2 is a circuit of the first preferred embodiment of the present invention;

FIG. 3 is a block diagram of a second preferred embodiment of the present invention;

FIG. 4 is a circuit of the second preferred embodiment of the present invention;

FIG. 5 is a block diagram of a third preferred embodiment of the present invention;

FIG. 6 is a circuit of the third preferred embodiment of the present invention;

FIG. 7 is a block diagram of a fourth preferred embodiment of the present invention;

FIG. 8 is a circuit of the fourth preferred embodiment of the present invention;

FIG. 9 shows the dimmer incorporated in the present invention;

FIG. 10 to FIG. 13 show the present invention applied in non-isolating transformer; and

FIG. 14 shows a wave diagram of the first preferred embodiment of the present invention.

### DETAILED DESCRIPTION OF THE INVENTION

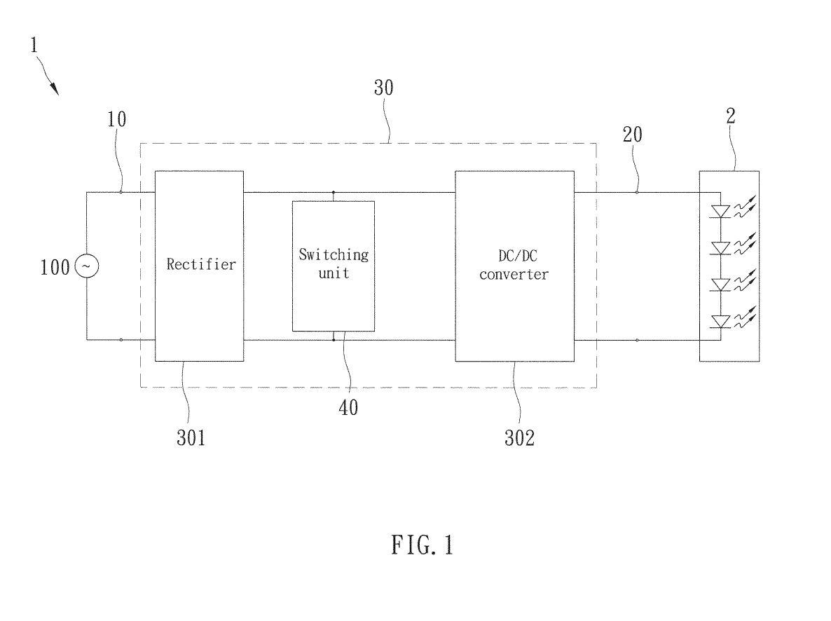

FIG. 1 shows a light source module of the first preferred embodiment, including a switching power supply 1 and plurality of LEDs 2. The switching power supply 1 receives power from an external power source 100, and supplies it to the LEDs 2. In the present invention, the power source 100 is AC power from the power station or AC/DC power from other power systems, such as wind power, solar power, geothermal power etc. The switching power supply 1 includes an input port 10, an output port 20, a transforming unit 30, and a switching unit 40.

The input port 10 electrically connects to the power source 100.

The output port 20 electrically connects to the LEDs 2.

The transforming unit 30 respectively connects to the input port 10 and the output port 20, and includes a rectifier 301 and a DC/DC converter 302. The rectifier 301 connects to the input port 10 to receive the AC current from the power source 100 and transform it into DC current. The DC/DC converter 302 connects to the rectifier 301 to receive the DC current, and transform it into a predetermined voltage or current level, and send it to the LEDs 2 through the output port 20.

The switching unit 40 is a self-oscillating circuit, such as RCC (ringing choke converter) or other self-oscillating circuits. The switching unit 40 electrically connects to the transforming unit 30 to turn on and turn off the power outputting from the transforming unit 30 that the transforming unit 30 supplies a constant current to the LEDs 2.

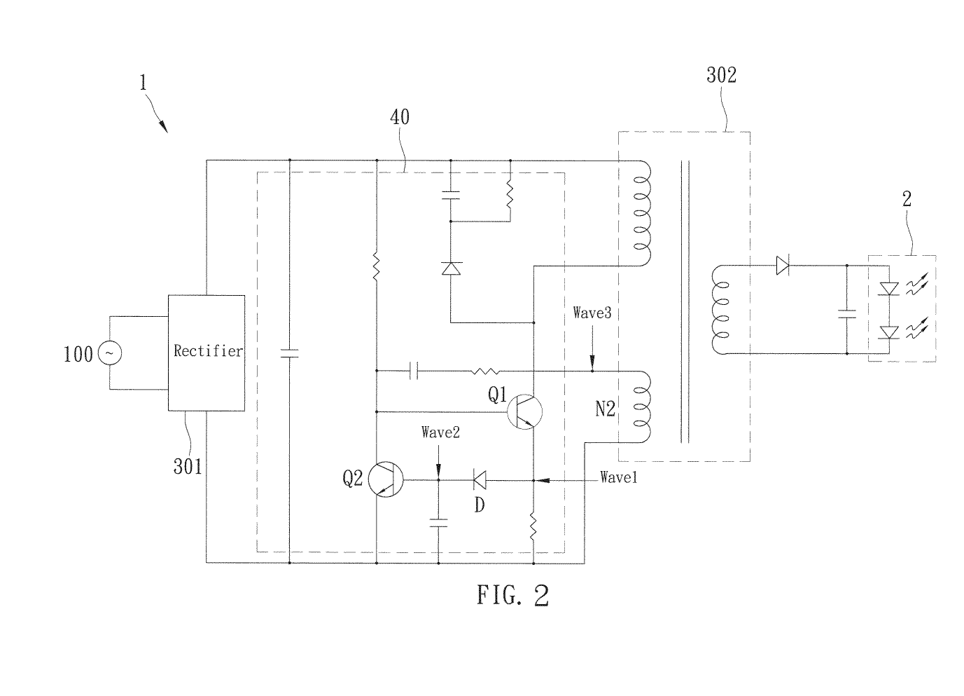

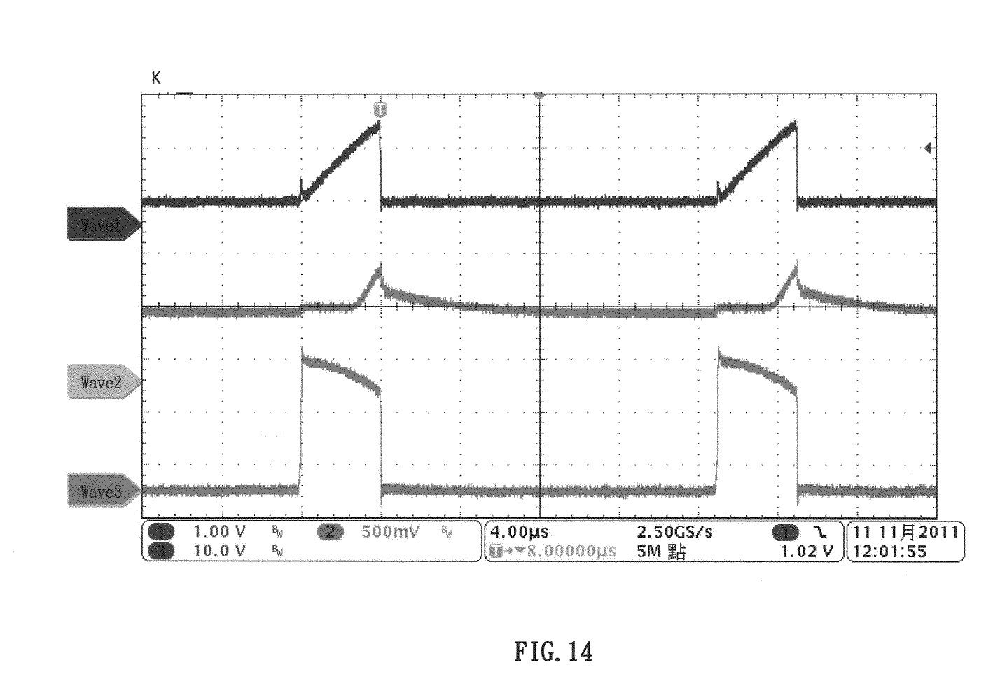

FIG. 2 shows a circuit of the first preferred embodiment, in which the DC/DC converter 302 is an isolating transformer. When the transforming unit 30 receives the AC power from the power source 100, a transistor Q1 is turned on to activate the DC/DC converter 302 to provide the LEDs 2 a predetermined current. As shown in FIG. 14, at this time, current of a collector of the transistor Q1 increases (wave 1), and voltage of a base of a transistor Q2 increases (wave 2) as well. When the voltage of the base of the transistor Q2 is greater than a predetermined level, the transistor Q1 will be turned off and the transistor Q2 will be turned on; thereafter the DC/DC converter 302 starts to release energy, and a coil N2 of the DC/DC converter 302 has negative voltage (wave 3). The energy of the DC/DC converter 302 will be out in a predetermined time after the transistor Q1 is turned off; thereafter the voltage of the DC/DC converter 302 turns to positive to turn on the transistor Q1 and turn off the transistor Q2. Consequently, the transistors Q1 and Q2 alternately turn on and turn off to make the DC/DC converter 302 provide a constant current to the LEDs 2.

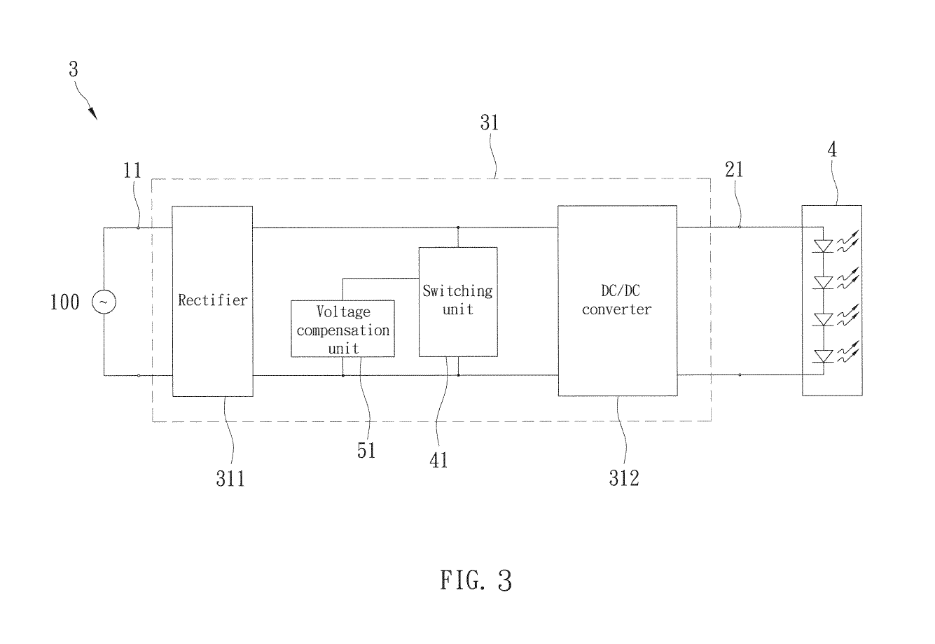

In the conventional device, the LEDs will receive variable current while the external power source is unstable. In order to overcome this drawback, as shown in FIG. 3, a switching power supply 3 of a light source module with a second preferred embodiment of the present invention includes an input port 11, an output port 21, a transforming unit 31, and a switching unit 41, and a voltage compensation unit 51. The voltage compensation unit 51 is electrically connected to the switching unit 41 to control the switching unit 41 to make the DC/DC converter 302 provide stable current while voltage of the external power source 100 changes.

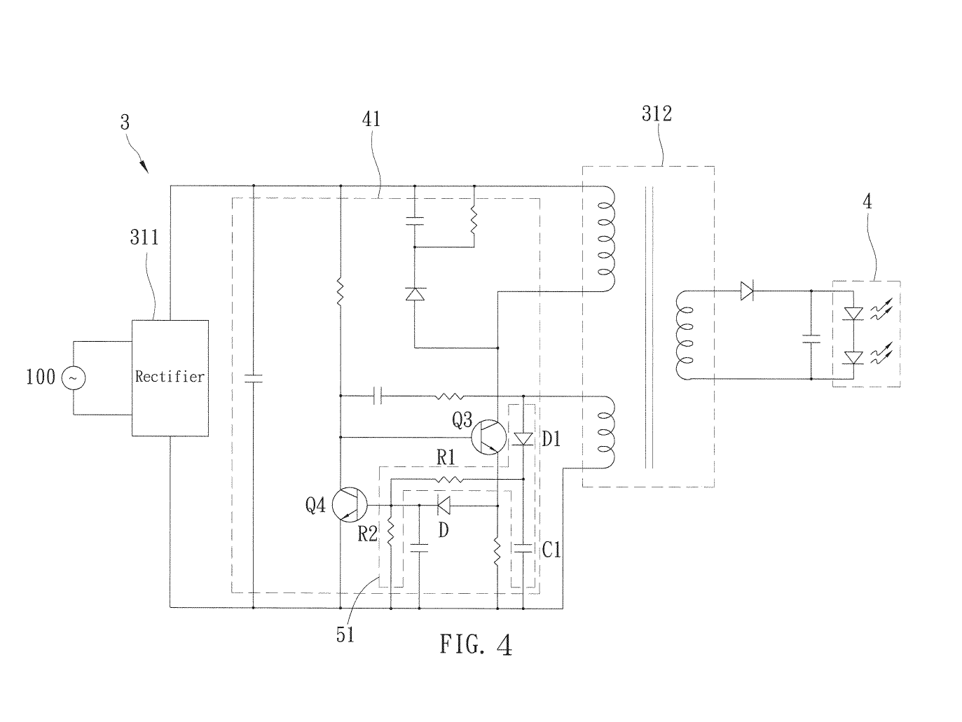

FIG. 4 shows a circuit of the second preferred embodiment, in which the voltage compensation unit 51 includes a diode D1, a capacitor C1, and two parallel resistors R1, R2 in series. When the power source 100 supplies variable voltages and the DC current generated from the rectifier 311 increases, it will increase the voltage of the capacitor C1 and speed up voltage increasing at the base of the transistor Q4, so that the transistor Q4 is turned on earlier to shorten the time of the transistor Q3 being turned on. Therefore, the present invention may provide a stable current when the input voltage increases.

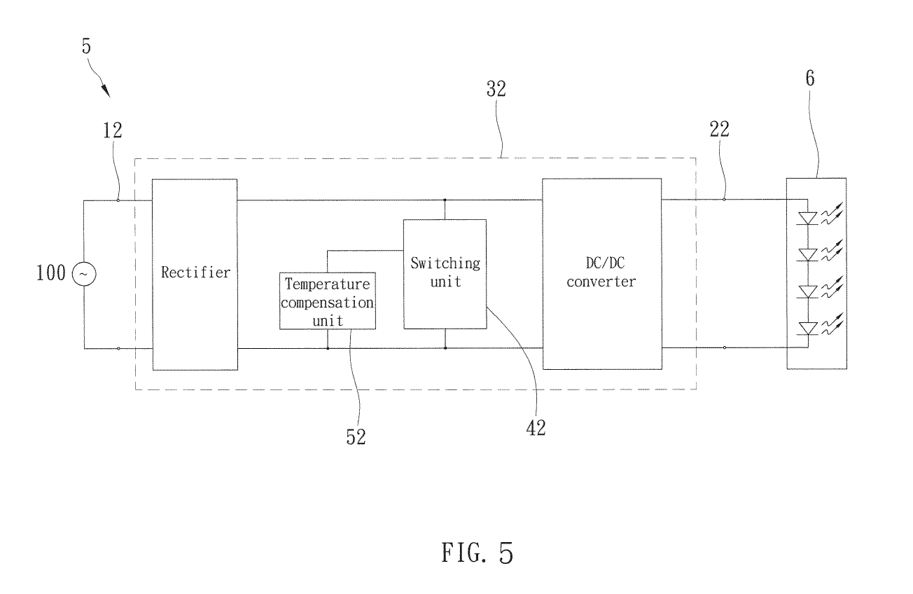

The temperature will increase after the power source module works for a time, and high temperature will cause the current supplying to the LEDs increasing. To avoid this drawback, a switching power supply 5 of the third preferred embodiment of the present invention, as shown in FIG. 5, includes an input port 12, an output port 22, a transforming unit 32, a switching unit 42, and a temperature compensation unit 52. The temperature compensation unit 52 is electrically connected to the switching unit 42 to control the switching unit 42. The temperature compensation unit 52 may make the transforming unit 32 provide the LED constant current when the temperature changes.

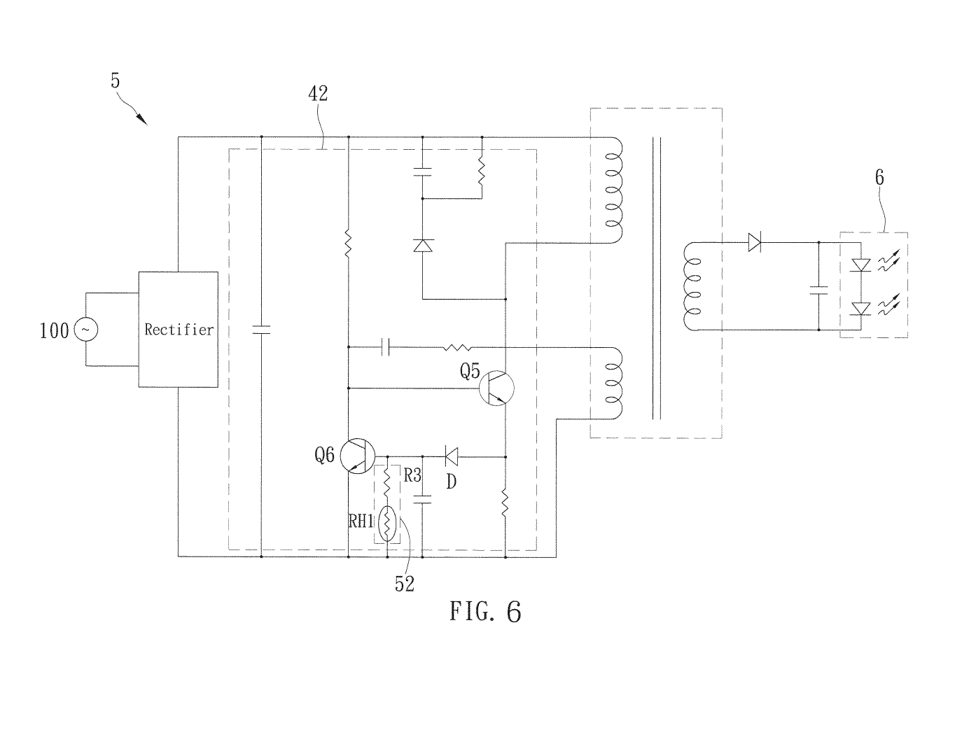

FIG. 6 shows a circuit of the third preferred embodiment, in which the temperature compensation unit 52 includes a resistor R3 and a thermistor RH1 in series. The resistance of the thermistor RH1 increases with increasing temperature to speed up voltage increasing at a base of a resistor Q6 and shorten the time of a transistor Q5 being turned on. Therefore, the switching power supply 5 may provide stable current when the temperature increases.

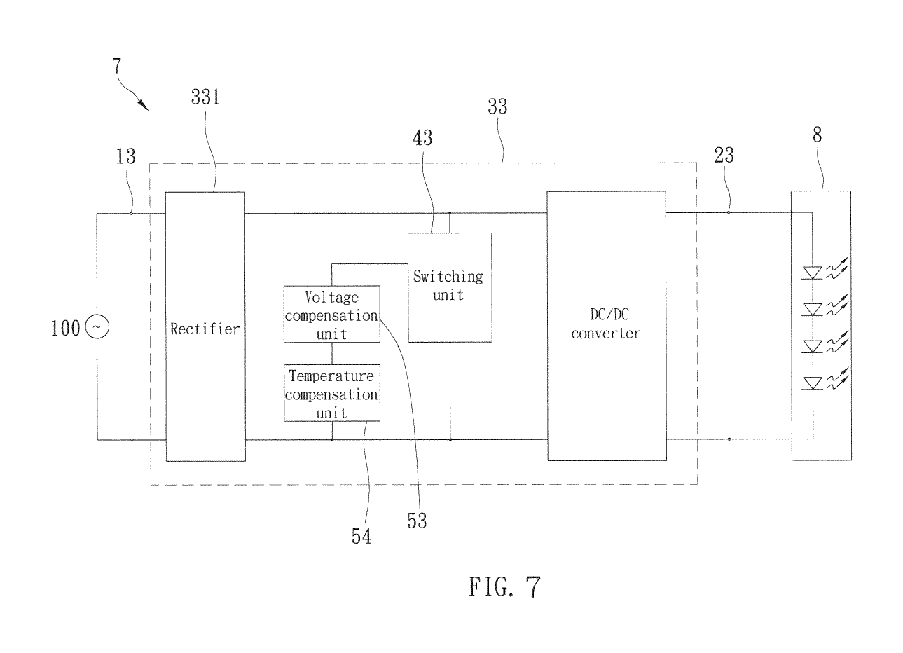

FIG. 7 shows a light source module with a switching power supply 7 of the fourth preferred embodiment of the present invention. The switching power supply 7 includes an input port 13, an output port 23, a transforming unit 33, a switching unit 43, a voltage compensation unit 53, and a temperature compensation unit 54. The voltage compensation unit 53 is electrically connected to the switching unit 43, and the temperature compensation unit 54 is electrically connected to the voltage compensation unit 53. The current will be kept stable when the voltage and/or the temperature change.

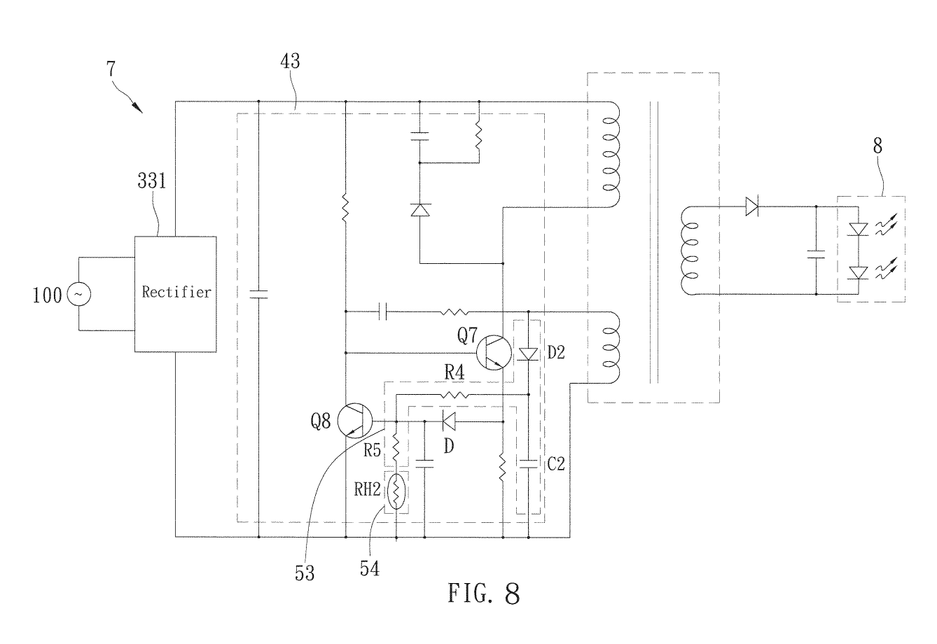

FIG. 8 shows a circuit of the fourth preferred embodiment of the present invention, in which the voltage compensation unit 53 includes a diode D2, a capacity C2, and two parallel resistors R4, R5 in series. The temperature compensation unit 54 includes a thermistor RH2, and the thermistor RH2 is electrically connected to the resistor R5 of the voltage compensation unit 53. When the power source 100 supplies variable voltages and the DC current generated from the rectifier 331 increases, it will increase the voltage of the capacitor C2 and speed up voltage increasing at a base of a transistor Q8 to shorten the time of a transistor Q7 being turned on. The resistance of the thermistor RH2 increases with increasing temperature to speed up voltage increasing at the base of the resistor Q8 and shorten the time of the transistor Q7 being turned on. Therefore, the present invention may provide a stable current when the input voltage and the temperature change.

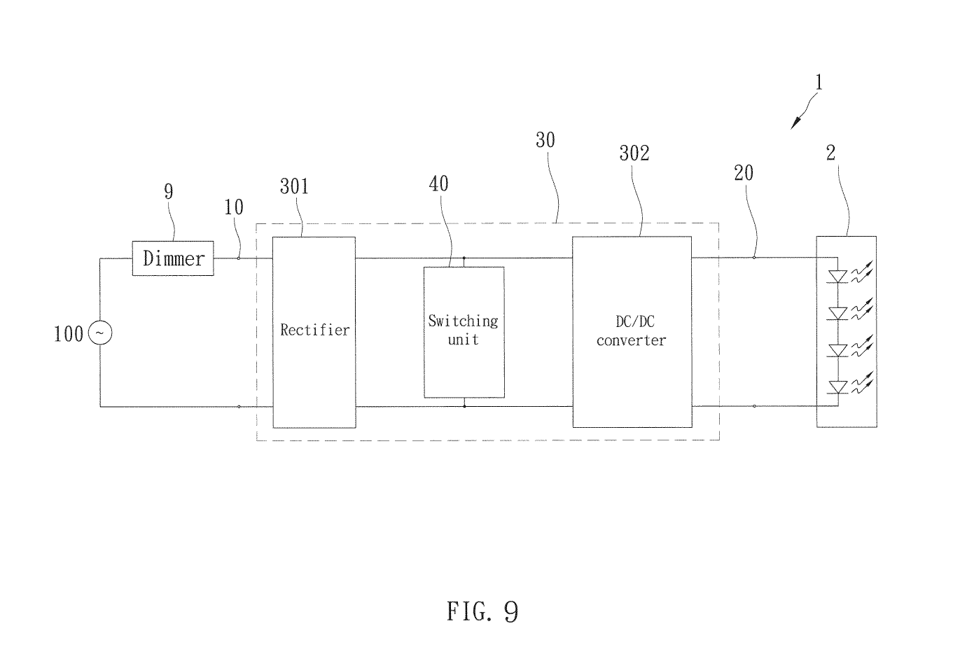

FIG. 9 shows a dimmer 9 incorporated in the light source module of the first preferred embodiment of the present invention. The dimmer 9 is between the power source 100 and the switching power supply 1 to change the brightness of the LEDs 2 by adjusting the power from the power source 100. Therefore, there will be no delay in the switching unit 40 after turning on the power to avoid hunting phenomenon between the dimmer 9 and the switching power supply 1 that the LEDs 2 do not flash. The dimmer 9 may be incorporated in the light source modules of the rest preferred embodiments of the present invention as well.

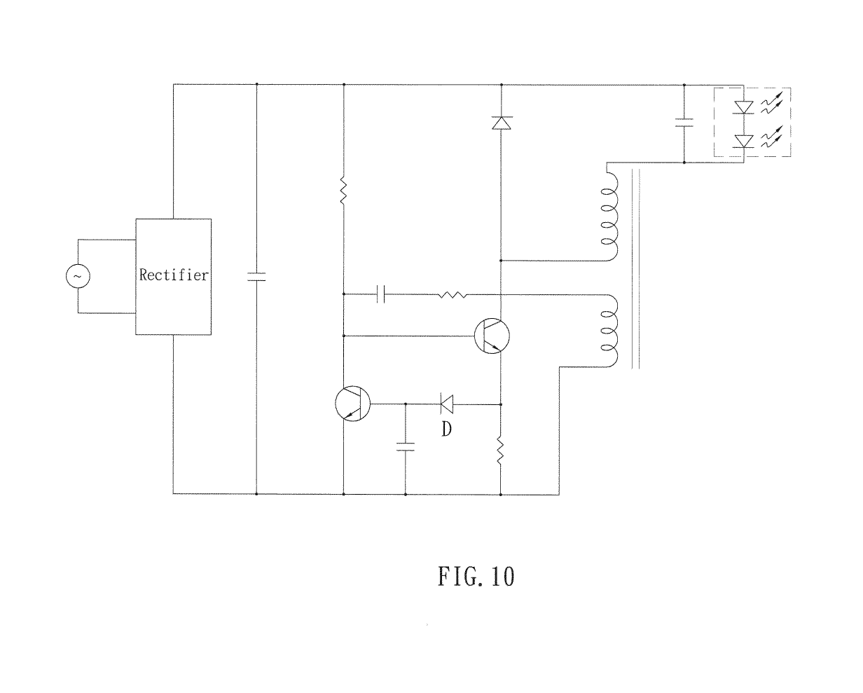

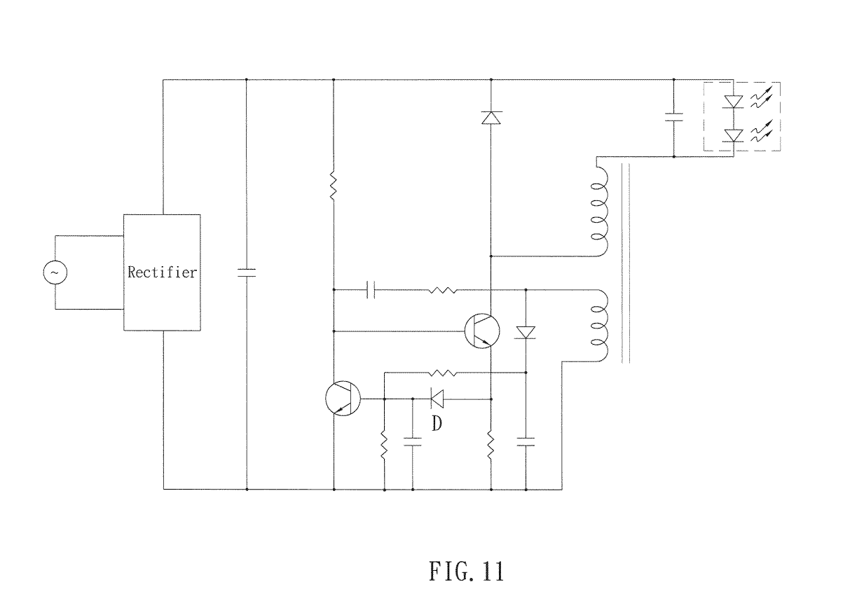

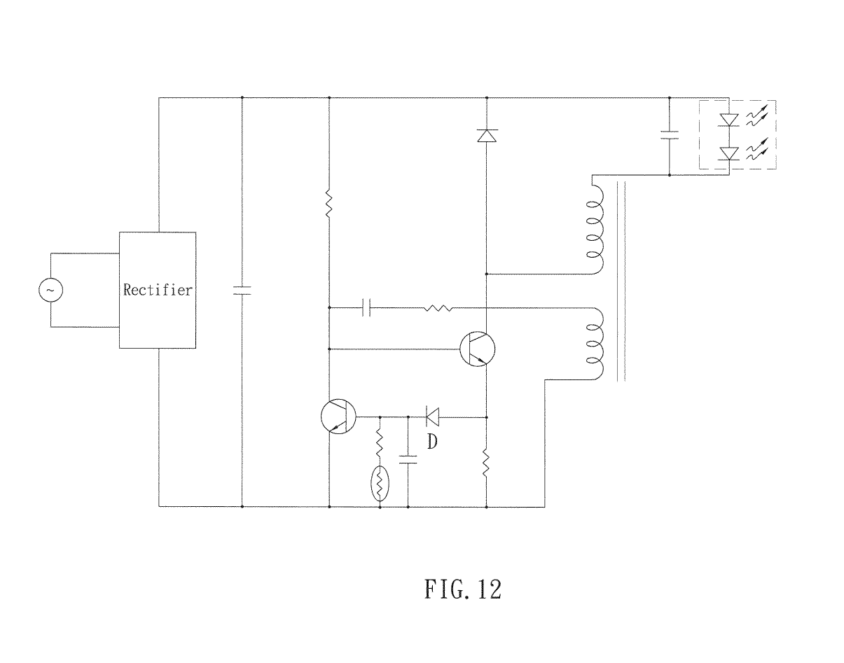

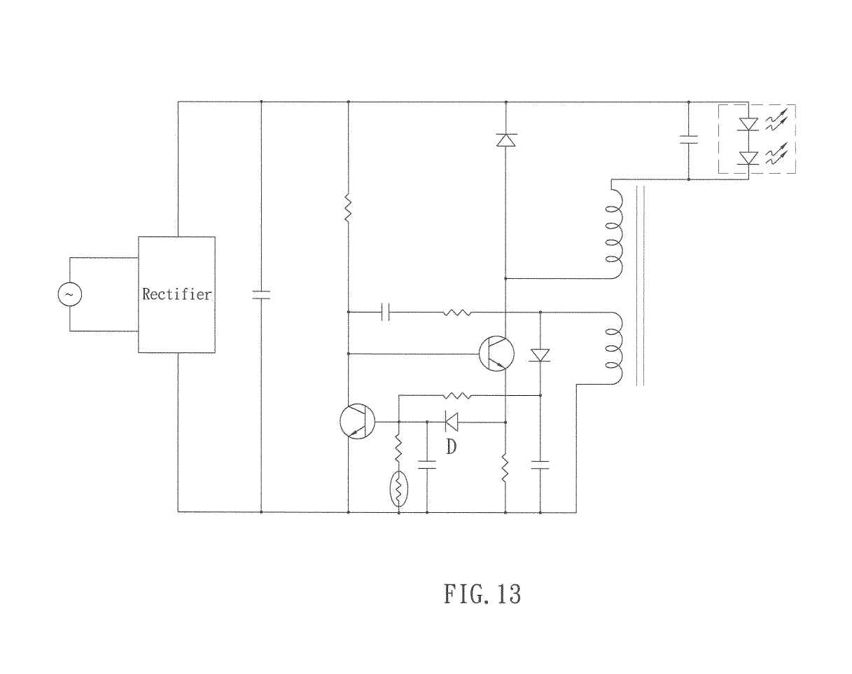

The switching power supplies as described above are applied to an isolated converter, and, however, they may be applied to a non-isolated converter as well, as shown in FIG. 10 to FIG. 14. In the preferred embodiments of the present invention, the diodes D in the switching unit may be replaced by resistors, and the transistors Q1, Q3, Q5, Q7 in the switching unit may be replaced by MOSFETs (metal-oxide-semiconductor field-effect transistor). The description above is a few preferred embodiments of the present invention and the equivalence of the present invention is still in the scope of claim construction of the present invention.

What is claimed is:

1. A light source module, comprising:
at least a light emitting diode; and
a switching power supply having an input port, an output port, a transforming unit, and a switching unit;
wherein an external power source is connected to the input port, the light emitting diode is electrically connected to the output port, and the transforming unit is between the input port and the output port to receive power of the external power source through the input port, transform the power, and send the power to the light emitting diode through the output port;
wherein the switching unit includes a ringing choke converter electrically connected to the transforming unit to make the transforming unit provide a constant current to the light emitting diode by turning on and turning off the power outputting from the transforming unit.

2. The light source module as defined in claim 1, further comprising a voltage compensation unit electrically connected to the switching unit to control the switching unit to make the transforming unit provide the constant current to the light emitting diode when voltage of the external power source changes.

3. The light source module as defined in claim 2, wherein the voltage compensation unit includes a diode, a capacity, and parallel resistors in series.

4. The light source module as defined in claim 2, further comprising a temperature compensation unit electrically connected to the voltage compensation unit to control the switching unit to make the transforming unit provide the constant current to the light emitting diode when temperature of the switching power supply changes.

5. The light source module as defined in claim 4, wherein the temperature compensation unit includes a thermistor.

6. The light source module as defined in claim 1, further comprising a temperature compensation unit electrically connected to the switching unit to control the switching unit to make the transforming unit provide the constant current to the light emitting diode when temperature of the switching power supply changes.

7. The light source module as defined in claim 6, wherein the temperature compensation unit includes a thermistor.

8. The light source module as defined in claim 1, wherein the transforming unit further includes a DC/DC inverter to transform the power form the external power source, and send the power to the light emitting diode.

9. The light source module as defined in claim 8, wherein the transforming unit further includes a rectifier electrically connected to the input port to transform the power from the external power source into DC current, and send the DC current to the DC/DC converter.

10. The light source module as defined in claim 1, further comprising a dimmer between the external power source and the switching unit to adjust the power from the external power source and send the power to the switching unit.

11. The light source module as defined in claim 1, wherein the switching unit includes two transistors coupled together to make the transforming unit provide the constant current by alternately turning on the transistors.

12. The method as defined in claim 1, wherein the switching unit includes a transistor and a metal-oxide-semiconductor field-effect transistor coupled together to make the transforming unit provide the constant current by alternately turning on the transistor and the metal-oxide-semiconductor field-effect transistor.

13. A light source module, comprising:
at least a light emitting diode; and
a switching power supply having an input port, an output port, a transforming unit, and a switching unit;
wherein an external power source is connected to the input port, the light emitting diode is electrically connected to the output port, and the transforming unit is between the input port and the output port to receive power of the external power source through the input port, transform the power, and send the power to the light emitting diode through the output port;
wherein the switching unit includes a self-oscillating circuit electrically connected to the transforming unit to make the transforming unit provide a constant current to the light emitting diode by turning on and turning off the power outputting from the transforming unit.
